(19) United States
(12) Patent Application Publication
(10) Pub. No.: US 2025/0298645 A1
(43) Pub. Date: Sep. 25, 2025

(54) METHODS, DEVICES, AND NON-TRANSITORY COMPUTER-READABLE MEDIA FOR ANALYZING AND IMPROVING DELAY FACTORS IN DISTRIBUTED DATA PROCESSING

(71) Applicant: NAVER CORPORATION, Seongnam-si (KR)

(72) Inventors: Jeongin JU, Seongnam-si (KR); Young Gon LEE, Seongnam-si (KR); Byungchang KWON, Seongnam-si (KR); Donghyun KIM, Seongnam-si (KR); Se Jin HWANG, Seongnam-si (KR); Seokchan YOON, Seongnam-si (KR); Ji Hye SEO, Seongnam-si (KR); Young Jin YANG, Seongnam-si (KR); Jaeyeon HAN, Seongnam-si (KR)

(73) Assignee: NAVER CORPORATION, Seongnam-si (KR)

(21) Appl. No.: 19/089,140

(22) Filed: Mar. 25, 2025

(30) Foreign Application Priority Data
Mar. 25, 2024 (KR) 10-2024-0040183

(51) Int. Cl. G06F 9/455; G06F 1/14

(52) U.S. Cl. CPC G06F 9/455; G06F 1/14

(57) ABSTRACT

A method for performing analysis on an application that performs distributed processing of data, the method including generating, by processing circuitry, simulation information for simulations of the application based on log files corresponding to the application, performing, by the processing circuitry, the simulations using the simulation information in a plurality of operating environments to obtain simulation results, the plurality of operating environments include an actual operating environment of the application and virtual operating environments, and one or more delay factors being removed in each of the virtual operating environments, and conducting the analysis on the application based on the simulation results.

### CROSS REFERENCE TO RELATED APPLICATION

The present application claims priority to Korean Patent Application No. 10-2024-0040183, filed Mar. 25, 2024, the entire contents of which are incorporated herein by reference.

### BACKGROUND

### Technical Field

The present disclosure relates to methods, devices, and non-transitory computer-readable media for analyzing and improving delay factors in distributed data processing for a user and, more particularly, to methods, devices, and non-transitory computer-readable media for analyzing and improving delay factors in distributed data processing, quantitatively analyzing factors causing delay in an application distributing and processing large amounts of data, and providing an improvement plan therefor.

### Description of the Related Art

Recently, technologies for efficiently processing larger amounts of data on the basis of clustering technology and other technologies are rapidly developing.

For example, various frameworks such as MapReduce or SPARK for large-scale data distributed processing are widely used.

However, for users who execute applications based on MapReduce or SPARK, not only is it difficult to accurately identify the degrees of data processing delay caused by various factors such as allocation delay of Executors such as containers during application execution, but also, building operating environments for efficiently executing the applications is challenging due to this difficulty.

### SUMMARY

Some example embodiments provide for a method for quantifying and accurately identifying the degrees of influence according to various delay factors that may occur during the execution of the users' applications operated on the basis of the frameworks for distributed data processing, and the method for further providing operating environments capable of efficiently executing the applications based the degrees of influence identified.

The present disclosure has been devised to solve the challenges of the related art as described above, and some example embodiments of the present disclosure provide a method, device, and non-transitory computer-readable medium for analyzing and improving delay factors in distributed data processing, the method, device, and non-transitory computer-readable medium quantifying and accurately identifying the degrees of influence according to various delay factors that may occur during the execution of a user's application operated on the basis of a framework for the data distributed processing.

More specifically, some example embodiments of the present disclosure is to provide a method, device and non-transitory computer-readable medium for analyzing and improving delay factors in data distributed processing, the method, device and non-transitory computer-readable medium recommending or providing operating environments for efficiently performing an application on the basis of analysis of the application operated by a framework for the distributed data processing.

Other detailed examples of the present disclosure will be clearly understood and determined by those skilled in the art, who are experts or researchers in this technical field, through the specific content described below.

According to some example embodiments of the present disclosure for solving the above-described challenge, there is provided a method for performing analysis on an application that performs distributed processing of data, the method including generating, by processing circuitry, simulation information for simulations of the application based on log files corresponding to the application, performing, by the processing circuitry, the simulations using the simulation information in a plurality of operating environments to obtain simulation results, the plurality of operating environments include an actual operating environment of the application and virtual operating environments, and one or more delay factors being removed in each of the virtual operating environments, and conducting the analysis on the application based on the simulation results.

In addition, according to some example embodiments of the present disclosure, there is provided a non-transitory computer-readable storage medium including instructions stored therein and configured to cause a computing device comprising a processor to implement a specific operation when executed by the processor, the specific operation including generating simulation information for simulations of an application based on log files corresponding to the application, performing the simulations using the simulation information in a plurality of operating environments to obtain simulation results, the plurality of operating environments including an actual operating environment of the application and virtual operating environments, and one or more delay factors are removed in each of the virtual operating environments, and conducting analysis on the application based on the simulation results.

In addition, according to some example embodiments of the present disclosure, there is provided a device for performing analysis on an application that performs distributed processing of data, the device including at least one processor, and a memory storing instructions configured to cause the device to implement a specific operation when executed by the processor, the specific operation including generating simulation information for simulations of the application based on log files corresponding to the application, performing the simulations using the simulation information in a plurality of operating environments to obtain simulation results, the plurality of operating environments including an actual operating environment of the application and virtual operating environments, and one or more delay factors being removed in each of the virtual operating environments, and conducting the analysis on the application based on the simulation results.

Accordingly, the method, device, and non-transitory computer-readable medium for analyzing and improving delay factors in distributed data processing according to some example embodiments of the present disclosure may quantify and accurately identify the degrees of influence according to various delay factors that may occur during execution of the user's application operated on the basis of the framework for the data distributed processing.

In addition, the method, device, and non-transitory computer-readable medium for analyzing and improving delay factors in distributed data processing according to some example embodiments of the present disclosure may recommend or provide operating environments for efficiently performing an application on the basis of analysis of the application operated by a framework for the data distributed processing.

The effects of the present disclosure are not limited to the above-described effects, and other effects that are not described will be clearly understood by those skilled in the art from the following content described in the present specification.

### BRIEF DESCRIPTION OF THE DRAWINGS

The accompanying drawings, which are included as part of the detailed description to aid understanding of the present disclosure, provide some example embodiments of the present disclosure and describe the technical idea of the present disclosure together with the detailed description.

FIG. 1 is a configuration diagram illustrating an application analysis system according to some example embodiments of the present disclosure.

FIG. 2 is a flowchart illustrating an application analysis method according to some example embodiments of the present disclosure.

FIGS. 3 to 6 are views illustrating the application analysis method according to some example embodiments of the present disclosure.

FIG. 7 is a view illustrating a detailed flowchart for an operation of performing simulations in the application analysis method according to some example embodiments of the present disclosure.

FIG. 8 is a view illustrating a configuration and operation of an analysis device for an application according to some example embodiments of the present disclosure.

FIGS. 9 to 15 are flowcharts illustrating detailed operations of the application analysis device according to some example embodiments of the present disclosure.

FIGS. 16A to 16C are views illustrating analysis results generated in accordance with the application analysis method according to some example embodiments of the present disclosure.

FIG. 17 is a configuration diagram of a device for analyzing application according to some example embodiments of the present disclosure.

### DETAILED DESCRIPTION

The present disclosure may be modified in various ways and has various examples. Hereinafter, some example embodiments will be described in detail on the basis of the attached drawings.

The following examples are provided to aid a comprehensive understanding of a method, device, and/or system described in the present specification. However, these are merely examples and the present disclosure is not limited thereto.

In addition, in describing the examples of the present disclosure, when it is determined that a detailed description of a known technology related to the present disclosure may unnecessarily obscure the subject matter of the present disclosure, the detailed description thereof will be omitted. In addition, terms to be described later are terms defined in consideration of functions in the present disclosure, which may vary according to the intention, custom, etc., of users or operators. Therefore, definitions of these terms should be made on the basis of the content throughout the present specification. The terms used in the detailed description are only for describing the examples of the present disclosure, and should not be construed as limiting in any way. Unless expressly used otherwise, expressions in the singular form include the meanings in the plural form. In the present description, expressions such as “comprising,” “including,” or “provided with” are intended to indicate certain characteristics, numbers, operations, elements, and any part or combination thereof, and other than those described above, it should not be construed to exclude the existence or possibility of one or more other characteristics, numbers, operations, elements, and any part or the combination thereof.

Terms such as first, second, etc., may be used to describe various components, but the components are not limited by the terms, and are used only for the purpose of distinguishing one component from another component.

Hereinafter, some example embodiments of a method, device, and non-transitory computer-readable medium for analyzing and improving delay factors in distributed data processing according to the present disclosure will be described in detail with reference to the attached drawings.

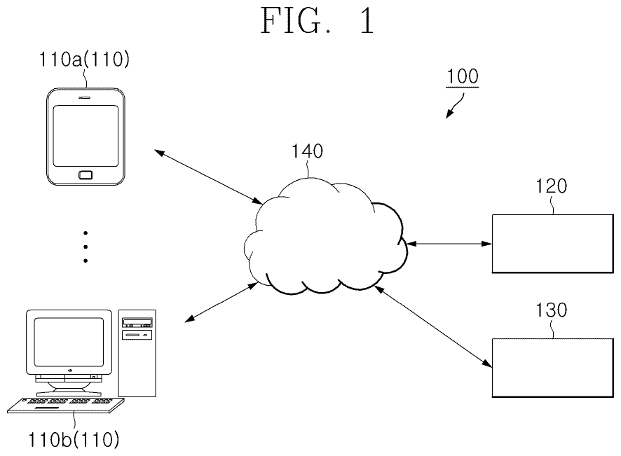

First, FIG. 1 illustrates a configuration diagram of an application analysis system 100 according to some example embodiments of the present disclosure. As may be seen in FIG. 1, an application analysis system 100 according to some example embodiments of the present disclosure may be configured to include: one or more user terminals 110a and 110b (may be collectively referred to herein as user terminals 110); a data distributed processing system 120 for providing data distributed processing for a user's application on the basis of a framework such as MapReduce or SPARK; an analysis device 130 for performing analysis on delay factors of the user's application; and/or a communication network 140.

In this case, as the terminals 110a and 110b, various terminal devices may be used, such as a personal computer (PC), a notebook PC, and the like that may connect to the data distributed processing system 120 and/or the analysis device 130 through the communication network 140 so as to execute the user's application or perform a request, etc., for analyzing tasks. Other than these terminal devices, various wired and wireless terminal devices such as tablet PCs, smartphones, personal digital assistants (PDAs), etc., may also be used as the terminals 110a and 110b.

In addition, the data distributed processing system 120 may be implemented by using one server or device, or a plurality of servers or devices, so as to provide data distributed processing for an application requested by a user through the terminals 110a and 110b, or may be implemented on the basis of clustering or cloud-based systems or the like, but the present disclosure is not necessarily limited thereto, and may also be implemented in various forms, such as by being implemented as a dedicated device.

In addition, the analysis device 130 may be implemented by using one server or device, or a plurality of servers or devices, or may be implemented on the basis of clustering or cloud-based systems so as to perform analysis on an application requested by the user through the terminals 110a and 110b and calculate the degree of influence and the like for various delay factors, or so as to further recommend improved operating environments. However, the present disclosure is not necessarily limited thereto, and may also be implemented in various forms, such as by being implemented as a dedicated device. According to some example embodiments, operations described herein as being performed by the application analysis system 100, each of the user terminals 110, the data distributed processing system 120, and/or the analysis device 130 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit

(GPU), a digital signal processor, a microcomputer, a field programmable gate array (FPGA), a System-on-Chip (SoC), a programmable logic unit, a microprocessor, application-specific integrated circuit (ASIC), etc.

Furthermore, according to some example embodiments of the present disclosure, the user's terminals 110a and 110b, the data distributed processing system 120, and/or the analysis device 130 do not necessarily have to be implemented in a separate forms, but it is also possible to implement them in various forms, such as by being implemented with two or more of the terminals 110a and 110b, the data distributed processing system 120, and/or the analysis device 130 in an integrated form.

In addition, the communication network 140 for connecting the user's terminals 110a and 110b, the data distributed processing system 120, and/or the analysis device 130 together may include a wired network and/or a wireless network, and specifically, may include various communication networks such as a local area network (LAN), a metropolitan area network (MAN), and/or a wide area network (WAN). In addition, the communication network 140 may also include the well-known World Wide Web (WWW) (or Internet). However, the communication network 140 according to the present disclosure is not limited to the networks listed above, and may also include at least some of known wireless data networks, known telephone networks, and/or known wired/wireless television networks.

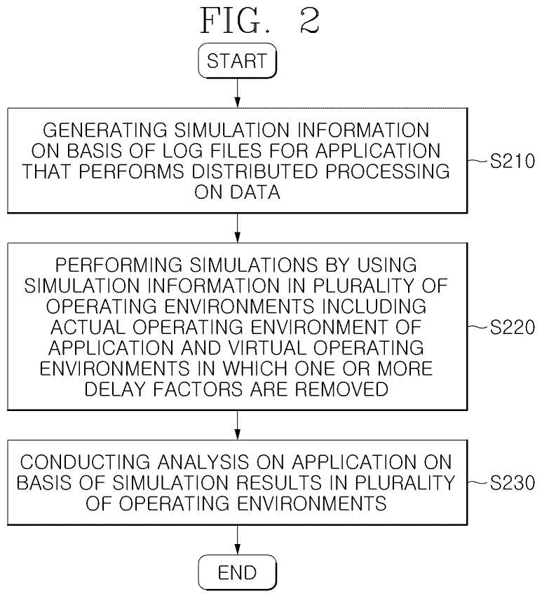

In addition, FIG. 2 illustrates a flowchart of an application analysis method according to some example embodiments of the present disclosure.

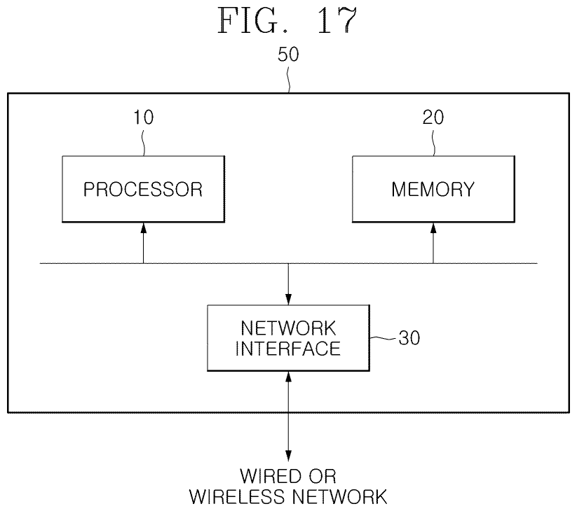

Here, for example, the method illustrated in FIG. 2 may be performed by the analysis device 130 that includes a processor and a memory, and performs analysis on an application performing distributed processing of data. Furthermore, the analysis device 130 may be implemented by including a computing device described below in relation to FIG. 17. For example, the analysis device 130 is provided with a processor 10, and the processor 10 may execute instructions configured to perform the analysis on the user's application.

More specifically, as may be seen in FIG. 2, the application analysis method according to some example embodiments of the present disclosure may include: in the analysis device 130, operation S210 of generating simulation information for simulations of an application on the basis of log files for the application that performs distributed processing for data; operation S220 of performing the simulations by using the simulation information in a plurality of operating environments including an actual operating environment of the application and virtual operating environments in which one or more delay factors are removed; and operation S230 of conducting analysis on the application on the basis of simulation results in the plurality of operating environments.

In this case, in generating operation S210, dependency relationships between one or more stages of the application may be generated on the basis of the log files.

In addition, in the generating operation S210, information about execution details of one or more unit tasks included in the one or more stages may be generated.

In addition, in the generating operation S210, one or more pieces of information may be generated from among the number of unit tasks included in the one or more stages, a time taken to perform each unit task, and/or a delay factor occurred in each unit task.

In addition, in the generating operation S210, information about one or more Executors to which one or more unit tasks are allocated may be generated.

Furthermore, in the generating operation S210, one or more pieces of information about one or more of allocation time for the one or more Executors and the delay factors occurred in the one or more Executors may be generated.

In addition, the performing operation S220 may include: operation S710 of performing a first simulation for the application in an actual operating environment; and operation S720 of performing second simulations for the application in virtual operating environments in which one or more of a plurality of delay factors are removed from the actual operating environment.

In this case, in operation S720 of performing the second simulations, the second simulations for the application may be performed in a plurality of virtual operating environments configured by combining and removing one or more of the plurality of delay factors from the actual operating environment.

In addition, in the conducting operation S230, the degrees of influence of one or more delay factors on the application may be calculated on the basis of a first execution completion time that is of the application and calculated through the simulation in the actual operating environment, and second execution completion times that are of the application and calculated through the simulations in the virtual operating environments.

In this case, in the conducting operation S230, the degree of influence of each of the plurality of delay factors on the application may be calculated on the basis of differences between the plurality of second execution completion times and the first execution completion time according to each of the plurality of delay factors.

In addition, in the conducting operation S230, a composite degree of influence of two or more delay factors on the application may be calculated on the basis of the second execution completion times in the virtual operating environments where two or more delay factors among the plurality of delay factors are applied together.

In addition, in the performing operation S220, the simulations are performed while changing setting values for the application, and in the conducting operation S230, optimal (or improved) setting values for the application may be calculated on the basis of the analysis of the application. According to some example embodiments, operation S230 may involve updating the setting values for the application, relative to those previously (or currently) configured for the application (e.g., relative to the setting values of the actual operating environment of the application), based on the analysis.

Accordingly, in the method, device, and computer program for analyzing the application for the user according to some example embodiments of the present disclosure may quantify and accurately identify the degrees of influence depending on various delay factors that may occur during the execution of the user's application operated on the basis of the framework for data distributed processing, and furthermore, may recommend or provide operating environments capable of efficiently executing the application on the basis of the analysis of the application operated on the basis of the framework for the data distributed processing.

Below, an application analysis method according to some example embodiments of the present disclosure is described in detail with reference to FIGS. 2 to 7.

First, in operation S210, an analysis device 130 generates simulation information for simulations of an application on the basis of log files for the application that performs distributed processing for data.

Here, the application may be operated on the basis of various frameworks for data distributed processing such as SPARK, MapReduce, Tez, and/or Trino, but the present disclosure is not necessarily limited thereto.

In addition, the log files may include all various forms of log files generated during the execution of the application, and may include a log file in the form of a log file stored in a storage and the like as an example, but may also include various forms of log files stored in a memory or a remote device.

Accordingly, the analysis device may generate log information for analysis of the application on the basis of the log files for the application.

In addition, the distributed data processing system for large-scale processing may configure, by considering dependency relationships between tasks, the entire task to be divided into stages to be performed in sequence, and configure the stages to be divided again into unit tasks. Each stage may have dependent stages to be performed beforehand, and a corresponding stage may be performed only after the dependent stages are completed.

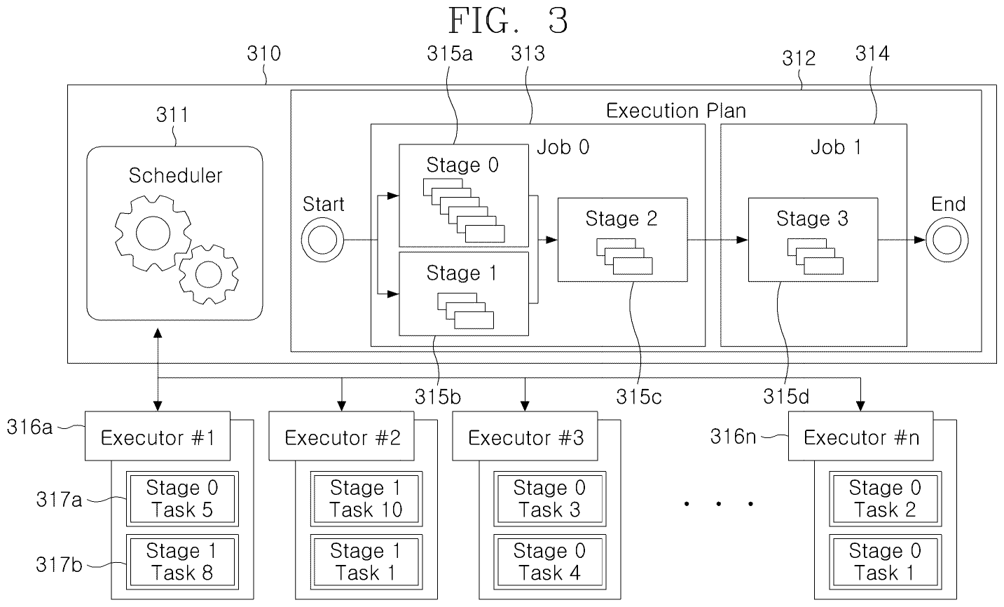

More specifically, as may be seen in FIG. 3, the application operated on the data distributed processing system 310 may include a plurality of stages (e.g., Stage 0 315a, Stage 1 315b, Stage 2 315c, and Stage 3 315d in FIG. 3), and each stage may include one or more unit tasks. In FIG. 3, in the dependent stages of Stage 2, Stage 0 and Stage 1 should be completed in order to perform Stage 2 with Stage 0 and Stage 1. According to some example embodiments, the data distributed processing system 310 may be the same as, similar to, or used to implement the data distributed processing system 120.

A scheduler 311 of the data distributed processing system 310 executes unit tasks 317a and 317b of each stage by allocating them to Executors 316a to 316n after referring to the dependency relationship of the stages according to an execution plan 312 of the application. According to some example embodiments, operations described herein as being performed by data distributed processing system 310, the scheduler 311, and/or each of the Executors 316a to 316n may be performed by processing circuitry.

In this case, each Executor may be operated as a container. The scheduler 311 conducts tasks, starting from a stage that is performable, and when all unit tasks of the stage are completed, the corresponding stage is completed.

However, in the data distributed processing system 410, multiple unit tasks are distributed and performed across a plurality of Executors, so some Executors or unit tasks may fail. In this case, the unit tasks may be operated in a way of identifying a part required to be re-performed (or otherwise, re-performed) and then re-performing the corresponding part. For example, in a case where a particular Executor fails, the unit tasks that are being performed in that particular Executor at the time of failure may also fail. In addition, intermediate results (e.g., Shuffle) of a previously completed stage may be lost in the failed Executor, and unit tasks that use the lost intermediate results as input may also fail. According to some example embodiments, the data distributed processing system 410 may be the same as, similar to, or used to implement the data distributed processing system 120 (and/or the data distributed processing system 310).

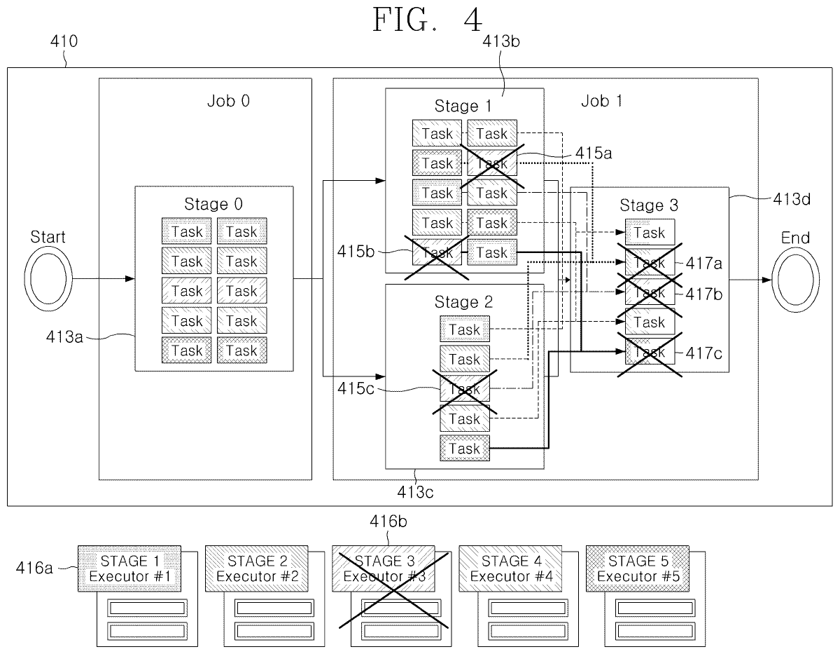

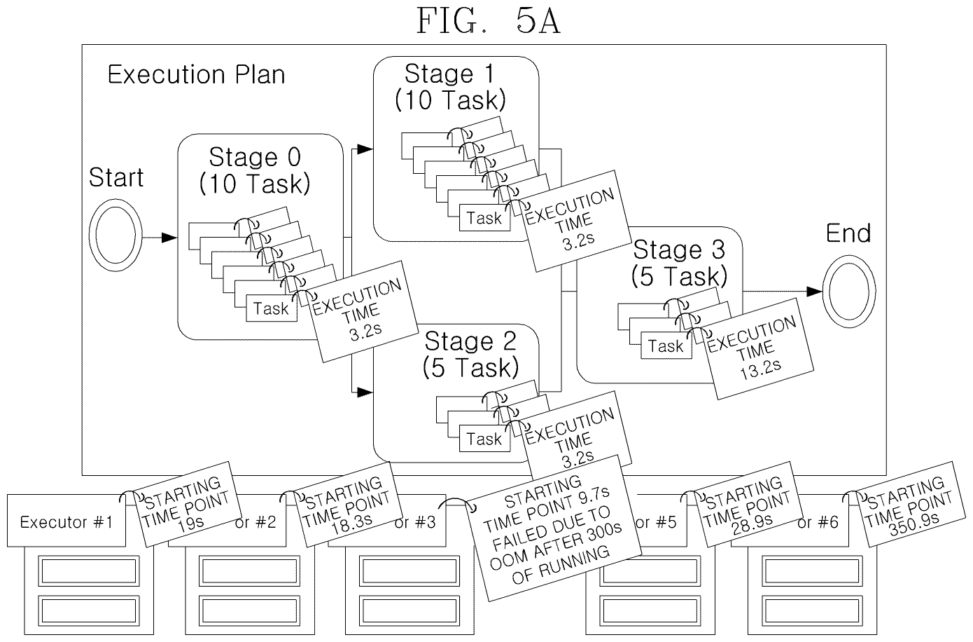

For a more specific example, in FIG. 4, after allocating unit tasks of Stage 0 413a to each of Executors 416a, 416b, and the like, so as to perform these unit tasks, the data distributed processing system 410 performs unit tasks of Stage 1 413b and Stage 2 413c, and then allocates unit tasks of Stage 3 413d to each of the Executors 416a, 416b, and the like, to perform these unit tasks. According to some example embodiments, operations described herein as being performed by the data distributed processing system 410, and/or each of the Executors 416a and 416b may be performed by processing circuitry.

In this case, in the example of FIG. 4, in a case where a third Executor (e.g., Executor #3) 416b fails during the execution of Stage 3, a unit task 416b being performed by a corresponding Executor has to be (or may be) re-performed. Furthermore, as the results (e.g., Shuffle) and the like, of the previously performed stages are also lost, the previously performed unit tasks (e.g., 415a, 415b, 415c, etc., in FIG. 4) may also be included in the unit tasks requiring re-execution (or to be re-executed). In addition, even though not performed by the failed Executor, other unit tasks 417a and 417c using the lost intermediate results as input may also be included in the unit tasks requiring the re-execution (or to be re-executed).

Referring to FIG. 4, stages that are in relationships using intermediate results (e.g., Shuffle) of other stages may be viewed as belonging to the same Job (e.g., job 1 314) (or similar jobs). The final stage of each Job may derive permanent results (e.g., saving the results to a shared file system, outputting the results to a user, etc.) as the tasks thereof are completed.

Accordingly, in the present disclosure, the simulations on the application are performed by applying the simulation information derived from the log files of the user's application on the basis of the simulators implemented by applying the scheduler, re-execution logic, and the like, of each framework of data distributed processing such as SPARK and MapReduce thereto, and based on this, the degrees of influence according to various delay factors that may occur during the execution of the application are quantified and accurately identified. Furthermore, based on this, the operating environments capable of efficiently executing the application may be recommended or provided. More specifically, in the generating operation S210, the analysis device may generate the information (e.g., the simulation information) required (or otherwise, used) for the simulations of the application on the basis of the log files generated through the operation of the application or may receive this information from the user. However, the present disclosure is not necessarily limited thereto, and the simulation information may be collected in various ways, such as by receiving this simulation information from an external server, etc.

In this case, the simulation information may include one or more pieces of information including: information about dependency relationships between stages; information about the execution details of the unit tasks such as the number of unit tasks included in the stages, the time taken to perform each unit task, and/or the delay factor occurred in each unit task; information about Executors such as the allocation time for each Executor and the delay factor occurred in each Executor; and/or other information.

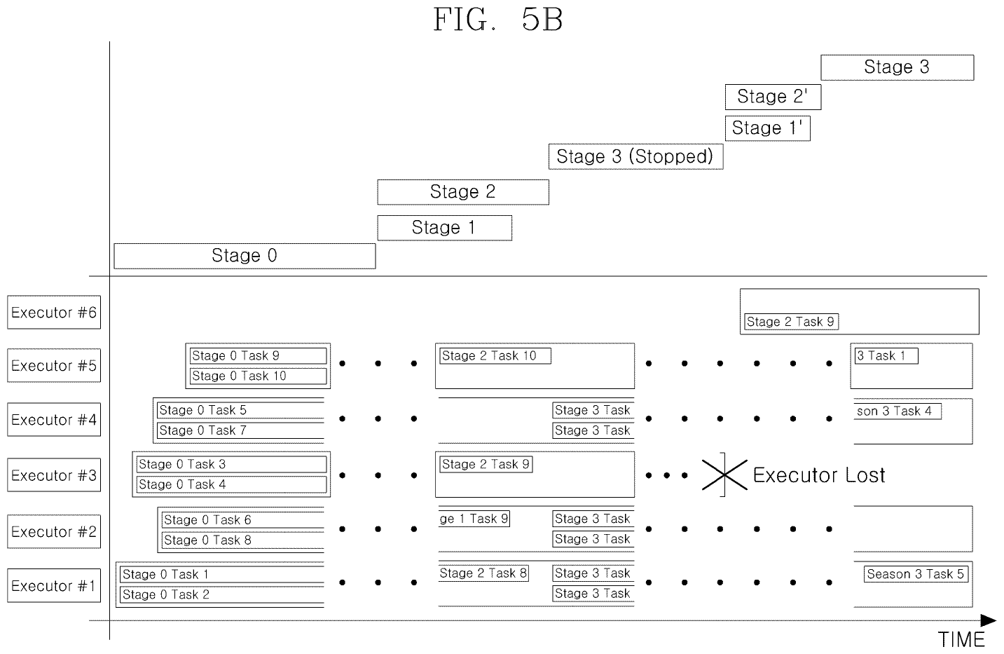

For a more specific example, FIG. 5A illustrates simulation information derived from the log files of the application, wherein the simulation information may include: a configuration of each stage and unit tasks; a time taken to perform each task; a time taken to configure and allocate each Executor; a time point at which a delay occurs due to failure; delay factors (e.g., in FIG. 5A, a delay has occurred because the third Executor (e.g., Executor #3) fails due to out of memory (OOM) at 300 seconds after execution); and other information.

Furthermore, with respect to the case of FIG. 5A on the basis of the log files, FIG. 5B illustrates an example of reconfiguring the entire task execution process, including a re-execution process after the failure of the third Executor (e.g., Executor #3).

Next, in operation S220, simulations are performed in the plurality of operating environments, including the actual operating environment of the application and the virtual operating environments in which one or more delay factors are removed, by using the generated simulation information.

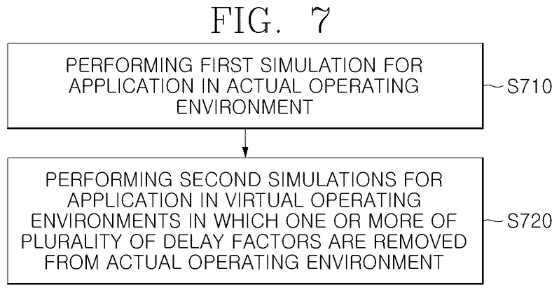

In this case, as shown in FIG. 7, operation S220 may include: operation S710 of performing a first simulation for the application in the actual operating environment; and operation S720 of performing second simulations for the application in the virtual operating environments in which one or two of the plurality of delay factors are removed for the actual operating environment.

Furthermore, in operation S720, the second simulations for the application may be performed in the plurality of virtual operating environments configured to combine and remove one or more of the plurality of delay factors from the actual operating environment.

More specifically, in the present disclosure, the delay factors causing execution delay of the application may include allocation delay of Executor, execution delay (e.g., Skewness) of a specific unit task in an execution phase, termination due to resource preemption of Executor, termination due to out of memory of Executor, etc. However, the present disclosure is not limited thereto, and some delay factors may be added or deleted depending on application fields. Furthermore, the plurality of delay factors may act in combination, thereby causing the delays.

Accordingly, in operation S220, the simulations are performed in various operating environments by applying or excluding such delay factors individually or in combination.

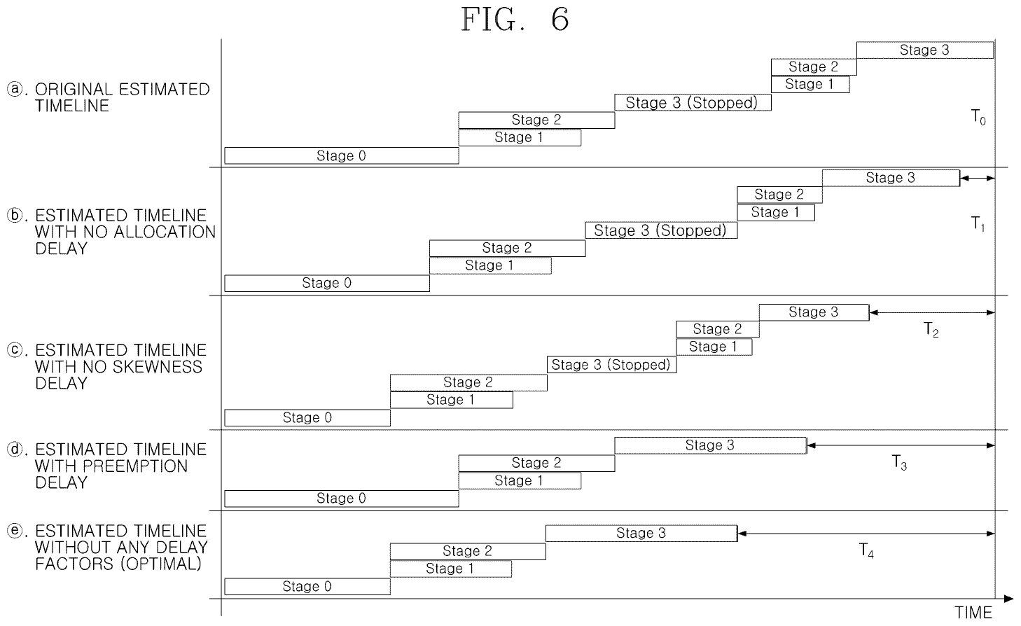

For a more specific example, as may be seen in FIG. 6, a simulation may first be performed in an actual operating environment that is identified from log files of an application (see (a) in FIG. 6).

Next, a simulation may be performed in virtual operating environments in which delay factors are excluded one by one or, further, in which the plurality of delay factors is excluded (see (b) to (e) in FIG. 6).

In this case, as may be seen in FIG. 6, when compared to a time taken to execute the application in the actual operating environment (see TO in FIG. 6), simulation results may be generated, in which times taken for execution are reduced according to respective delay factors in the virtual operating environments where one or more delay factors are removed (see T1 to T4 in FIG. 6).

Accordingly, in operation S230, analysis of the application is conducted on the basis of the simulation results in the plurality of operating environments.

Here, in operation S230, the degrees of influence of one or more delay factors on the application may be calculated on the basis of a first execution completion time that is of the application and calculated through the simulation in the actual operating environment, and second execution completion times that are of the application and calculated through the simulations in the virtual operating environments.

In this case, in operation S230, the respective degrees of influence of the plurality of delay factors on the application may be calculated on the basis of differences between the plurality of second execution completion times according to each of the plurality of delay factors and the first execution completion time. For example, a difference between the first execution completion time, which is the simulation result when the delay factors are included as it is, and a second execution completion time, which is a simulation result when a specific delay factor is excluded, may be calculated as a degree of influence of the corresponding delay factor.

For a more specific example, referring to FIG. 6, the degrees of influence of the respective delay factors on the application may be calculated on the basis of the first execution completion time TO calculated through the simulation in the actual operating environment, and the second execution completion times calculated through the simulations in the virtual operating environments.

In this case, a delay time due to an allocation delay of Executor may be T1, a delay time due to an execution delay (e.g., Skewness) of specific unit task in an execution phase may be T2, and a delay time due to termination caused by resource preemption of Executor may be T3. Based on this, a degree of delay contribution (%) due to each delay factor may be obtained and calculated as a degree of influence for each delay factor.

In addition, in operation S230, a composite degree of influence of two or more delay factors on the application may be calculated on the basis of second execution completion times in virtual operating environments to which two or more delay factors among the plurality of delay factors are applied. For example, in a case where a difference between a first execution completion time, which is a simulation result when the delay factors are included as they are, and a second execution completion time, which is a simulation result when all the delay factors are excluded, is greater than the sum of degrees of influence obtained when the respective delay factors are excluded, the corresponding difference may be calculated as the composite degree of influence of the delay factors.

For a more specific example, in a situation where only an allocation delay factor and an execution delay factor exist, when a first execution completion time calculated through a simulation in an actual operating environment including all the delay factors is 60 seconds, a second execution completion time in a virtual operating environment excluding the allocation delay of an Executor is 55 seconds, a second execution completion time in a virtual operating environment excluding an execution delay (e.g., Skewness) of a specific unit task is 50 seconds, and a second execution completion time in a virtual operating environment excluding all the delay factors (e.g., Allocation and Skewness) is 30 seconds, a degree of influence of the allocation delay may be calculated to be approximately 8% (60 seconds-55 seconds=5 seconds), it may be calculated such that a degree of influence of the execution delay (e.g., Skewness) of the unit task is approximately 16% (60 seconds−50 seconds=10 seconds), and a composite degree of influence of the allocation delay and execution delay factors is approximately 25% ((60 seconds−30 seconds)−5 seconds−10 seconds=15 seconds).

In addition, in the present disclosure, it is possible to quantitatively analyze and provide the degrees of influence for respective delay factors in various aspects, such as a time taken for application execution and an amount of resource usage, through simulations in various operating environments. Furthermore, it is possible to guide countermeasures for major delay factors.

Furthermore, in the present disclosure, in operation S220, simulations may be performed while changing setting values for the application, and in operation S230, optimal (or improved) setting values for the application may be calculated and provided on the basis of the analysis of the application.

For a more specific example, in the present disclosure, in addition to various delay factors, it is possible to perform simulations while changing setting values (e.g., the number of concurrent Executors, etc.) for the application, whereby setting values most suitable for the user's situation may be calculated or provided. For example, a method may be suggested in which through analysis of the application executed with 40 Executors, the number of Executors is changed to 80 when reducing execution time is important, the number of Executors is changed to 25 when reducing resource usage is important, and/or the number of Executors is changed to 55 when efficiency in execution time relative to resource usage is important.

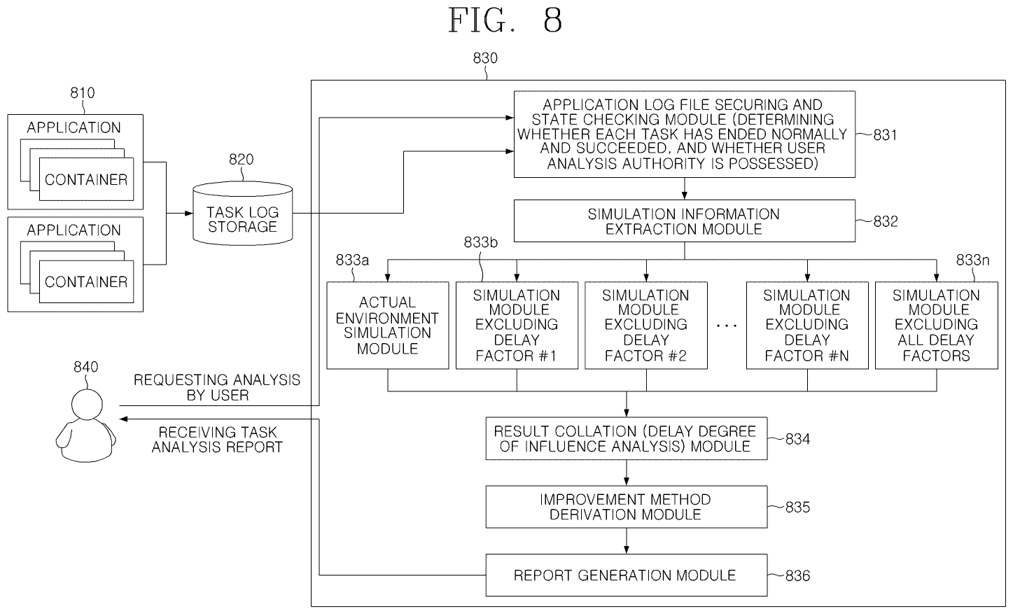

Furthermore, FIG. 8 illustrates a configuration and operation of an analysis device for an application according to some example embodiments of the present disclosure.

As may be seen in FIG. 8, the analysis device 830 for the application 810 may include an application log file securing and state checking module 831, a simulation information extraction module 832, a plurality of simulation modules 833a, 833b to 833n, a result collation module 834, an improvement method derivation module 835, and/or a report generation module 836. According to some example embodiments, the analysis device 830 may be the same as, similar to, or used to implement the analysis device 130. According to some example embodiments, operations described herein as being performed by the analysis device 830, the application log file securing and state checking module 831, the simulation information extraction module 832, each among the plurality of simulation modules 833a, 833b to 833n, the result collation module 834, the improvement method derivation module 835, and/or the report generation module 836 may be performed by processing circuitry.

In this case, when receiving an analysis request for an application from a user 840, the application log file securing and state checking module 831 may collect log files for the application targeted for analysis from a task log storage 820, and the like, and check whether tasks are normally terminated and successful.

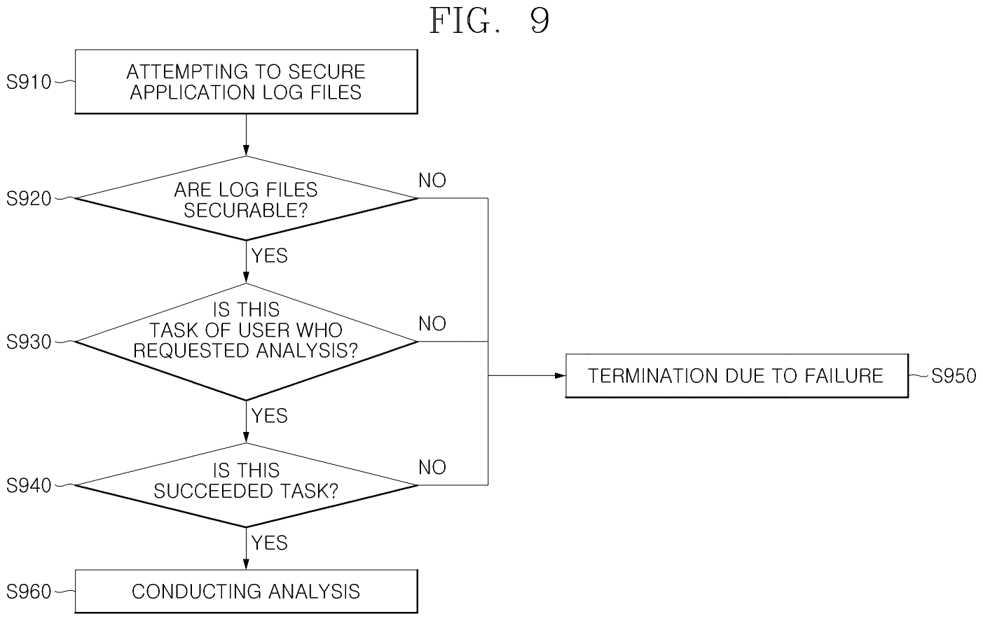

More specifically, referring to FIG. 9, in operation S910, the application log file securing and state checking module 831 first attempts to secure log files for the application targeted for analysis from the task log storage 820, etc.

In operation S920, whether the log files is securable is checked, and in operation S930, in a case where the log files may be securable, whether the relevant application corresponds to the tasks of the user who has requested the analysis may be checked for security reasons, and the like.

In addition, in operation S940, the application log file securing and state checking module 831 checks whether the application targeted for analysis corresponds to the task that is successfully completed without abnormal termination.

The reason is that in the present disclosure, the analysis is performed by comparing simulation results for various virtual operating environments on the basis of an actual operating environment in which the tasks are successfully completed.

Accordingly, in operation S960, the application log file securing and state checking module 831 proceeds to perform the analysis on the application in a case where all conditions of three operations S920, S930, and S940 described above are satisfied. In operation S950, in a case where even one condition is not satisfied, this operation terminates without performing the analysis.

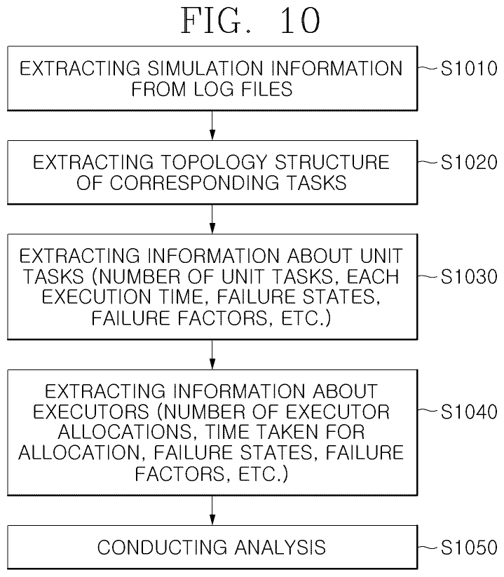

Next, as may be seen in FIG. 10, in operation S1010, the simulation information extraction module 832 first extracts simulation information for performing simulations of the application from the secured log files.

Next, in operation S1020, the simulation information extraction module 832 extracts topology regarding dependency relationships between stages for the application targeted for analysis.

More specifically, the simulation information extraction module 832 may extract a submission time point and a completion time point or order of each stage from the log files, and based on this, extract the topology, such as the dependency relationships between each of the stages.

For a more specific example, a case where topology for the application targeted for analysis is extracted on the basis of a log file below will be described.

### Example of Log File

Task Start
10:00 Stage 0 submit
10:05 Stage 0 done
10:06 Stage 1 submit
10:07 Stage 2 submit
10:08 Stage 2 done
10:10 Stage 1 done
10:11 Stage 3 submit
10:15 Stage 3 done
Task Termination

In this case, it may be seen that tasks are composed of four stages from Stage 0 to Stage 3. Since Stage 0 has no stage preceding it at a start time point, it may be seen that there is no stage that has to be completed (or is completed) beforehand. Since a submission time point of each of Stages 1 and 2 is after a time point at which Stage 0 is completed, they may be determined as stages performed after Stage 0 is completed. Since a submission time point of Stage 3 is after a time point at which Stages 1 and 2 are completed, it may be determined as a stage performed after Stages 1 and 2 are completed.

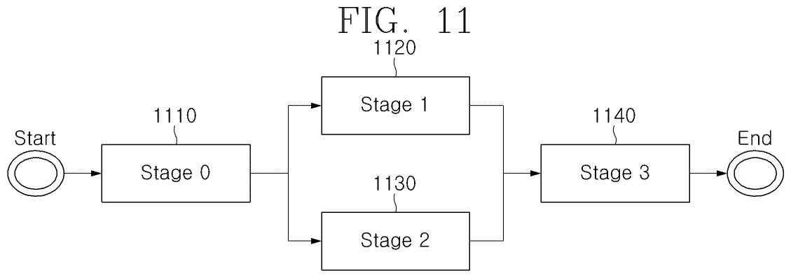

Accordingly, as may be seen in FIG. 11, it is possible to extract topology including dependency relationships of Stage 0 1110, Stage 1 1120, Stage 2 1130, and Stage 3 1140 from log files.

In addition, in operation S1030, the simulation information extraction module 832 extracts information about unit tasks, such as the number of unit tasks, and/or an execution time, failure state, and/or failure factor of each unit task.

In addition, in operation S1040, the simulation information extraction module 832 extracts information about each Executor, such as the number of allocations, allocation time taken, failure state, and/or failure factor of each Executor.

Accordingly, in operation S1050, the simulation information extraction module 832 proceeds to perform analysis on the application on the basis of the simulation information, etc., generated on the basis of the log files.

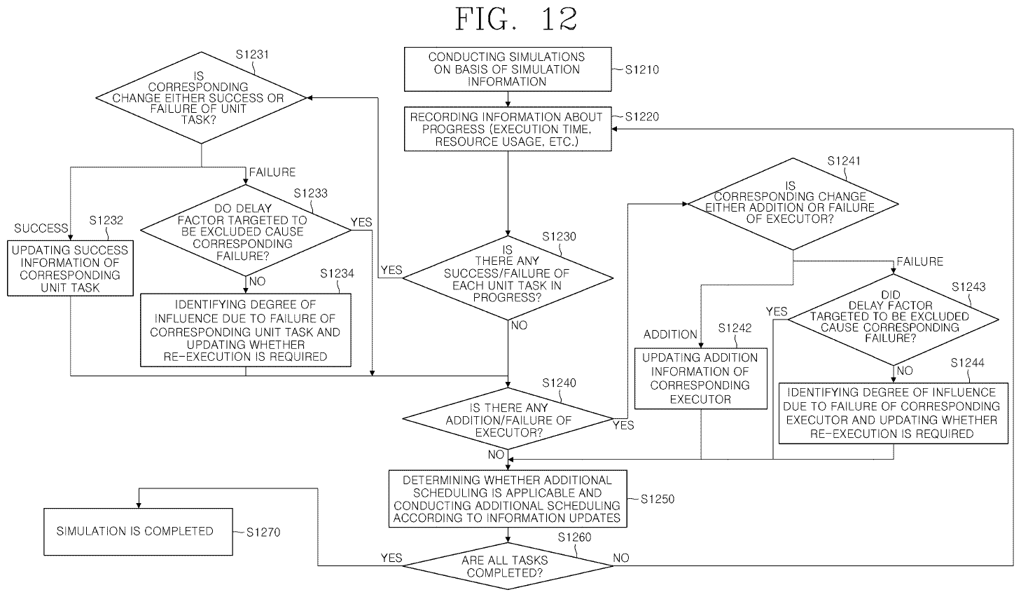

Next, as may be seen in FIG. 12, the plurality of simulation modules 833a, 833b to 833n perform simulations for the actual operating environment and respective virtual operation environments.

More specifically, each simulation module first performs a simulation on the basis of the generated simulation information in operation S1210, and records information about progress, such as execution time and resource usage in operation S1220.

Next, in operation S1230, the simulation module determines whether a success or failure has occurred each unit task in progress, and performs a sub-processing routine for the success or failure of each unit task as follows in a case where the success or failure has occurred.

First, in operation S1231, the sub-processing routine for the success or failure of a unit task determines whether the unit task has succeeded or failed.

At this time, in operation S1232, in a case of being determined as successful, information about the success of the corresponding unit task is updated.

In contrast, in operation S1233, in a case of being determined as failure, whether the failure is caused by a delay factor to be excluded from the simulation is determined. In operation S1234, in a case of being determined as not the delay factor to be excluded, a degree of influence of the failure of the corresponding unit task is identified and whether re-execution is required (or to be performed) or not is updated.

In addition, in operation S1240, the simulation module determines whether addition or failure of an Executor has occurred, and performs a sub-processing routine for addition or failure of the Executor as follows in a case where the addition or failure has occurred.

First, in operation S1241, the sub-processing routine for addition or failure of Executor determines whether the Executor has been added or failed.

At this time, in operation S1242, in a case of being determined as an addition, information about the addition of the corresponding Executor is updated.

In contrast, in operation S1243, in a case of being determined as failure, whether the failure is caused by a delay factor to be excluded from the simulation is determined. In operation S1244, in a case of being determined as not the delay factor to be excluded, a degree of influence of the failure of a corresponding Executor is identified and whether re-execution is required (or to be performed) or not is updated.

In addition, in operation S1250, the simulation module determines whether additional scheduling is available according to the information update and then conducts scheduling.

Next, in operation S1260, the simulation module determines whether all tasks are completed. The simulation is completed in operation S1270 when all the tasks are completed. In a case where all the tasks are not completed, the current operation returns to operation S1220 and repeats the processing operations.

Next, the result collation module 834 collates results of simulations performed in the plurality of simulation modules 833a, 833b to 833n, and based on this, analyzes a degree of influence and the like of each delay factor.

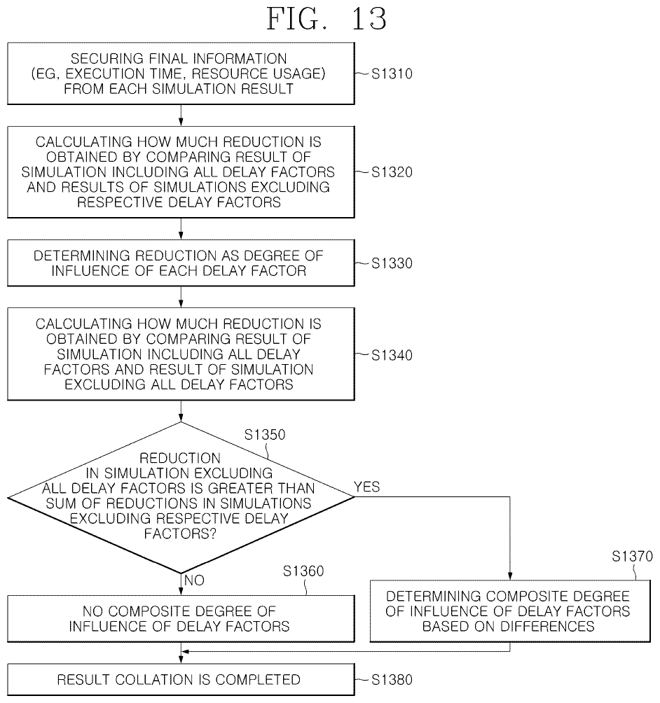

More specifically, as may be seen in FIG. 13, in operation S1310, the result collation module 834 first secures a time taken for execution, resource usage, and the like, from each simulation result.

Next, in operation S1320, the result collation module 834 determines how much the time taken, and the like, have been reduced by comparing the results of the simulations in the virtual operating environments excluding the respective delay factors and the result of the simulation in the actual operating environment including all the delay factors.

Next, in operation S1330, the result collation module 834 determines the degree of influence of each delay factor on the basis of the reduced time taken for each simulation.

In addition, the result collation module 834 calculates, in operation S1340, how much a simulation time is reduced in the virtual operating environment excluding all the delay factors compared to the simulation result when all the delay factors are included, determines, in operation S1350, whether the reduced time of the simulation excluding all the delay factors is greater than the sum of the reduced times taken in the simulations in the virtual operating environments excluding the respective delay factors, determines, in operation S1370, a composite degree of influence due to the plurality of delay factors based on this or determines, in operation S1360, that there is no composite degree of influence, and completes, in operation S1380, the result collation as well as the analysis on the degrees of influence.

Next, the improvement method derivation module 835 derives an improvement plan for the application on the basis of each delay factor's degree of influence calculated through each simulation.

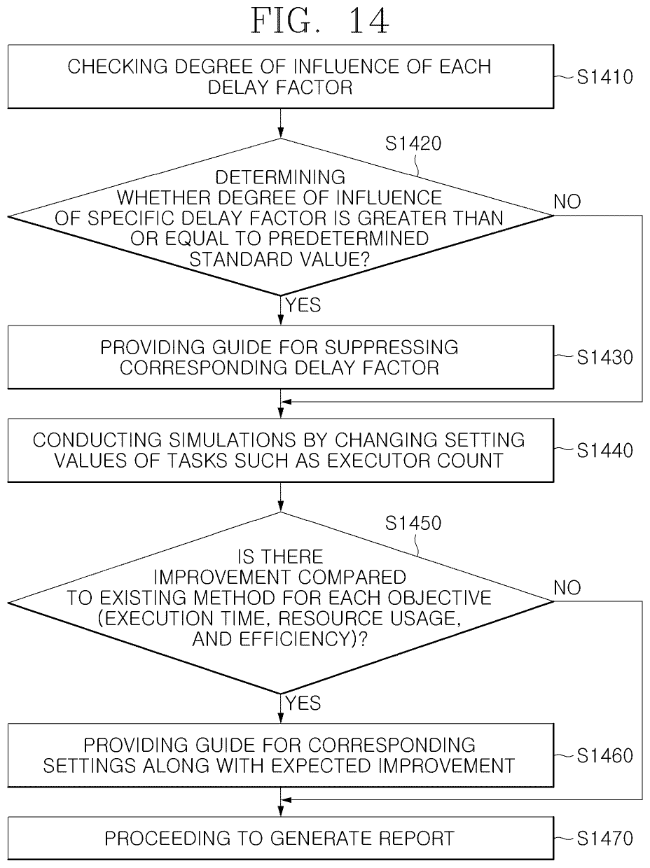

More specifically, as may be seen in FIG. 14, in operation S1410, the improvement method derivation module 835 first checks the degree of influence of each delay factor.

Next, in operation S1420, the improvement method derivation module 835 determines whether the degree of influence of a specific delay factor is greater than or equal to a predetermined (or alternatively, given) standard value. According to some example embodiments, the standard value may be a design parameter determined through empirical study.

At this time, in operation S1430, in a case where the degree of influence of the specific delay factor is greater than or equal to the standard value, the improvement method derivation module 835 may provide the user with a guide for improving the corresponding delay factor.

Next, the improvement method derivation module 835 performs various simulations by changing setting values such as an Executor count in operation S1440, determines based on this whether there is improvement compared to the existing method for each (or any) objective (or priority) such as the time taken for execution, resource usage, and efficiency in operation S1450, provides a guide for the corresponding setting values along with the expected improvement effect in operation S1460 in a case where there is an improvement, and generates a report for the user in operation S1470. According to some example embodiments, the analysis device 830 may provide (e.g., build) an operating environment for use in executing the application based on the setting values. For example, the operating environment may be configured to reflect the setting values provided in operation S1460. According to some example embodiments, the analysis device 830 provides the operating environment in response to an input from a user (e.g., the user 840), but some example embodiments are not limited thereto. According to some example embodiments, the analysis device 830 provides the operating environment in response to determining there is improvement compared to the existing method in operation S1450. According to some example embodiments, the data distributed processing system 120 may execute the application in the provided operating environment.

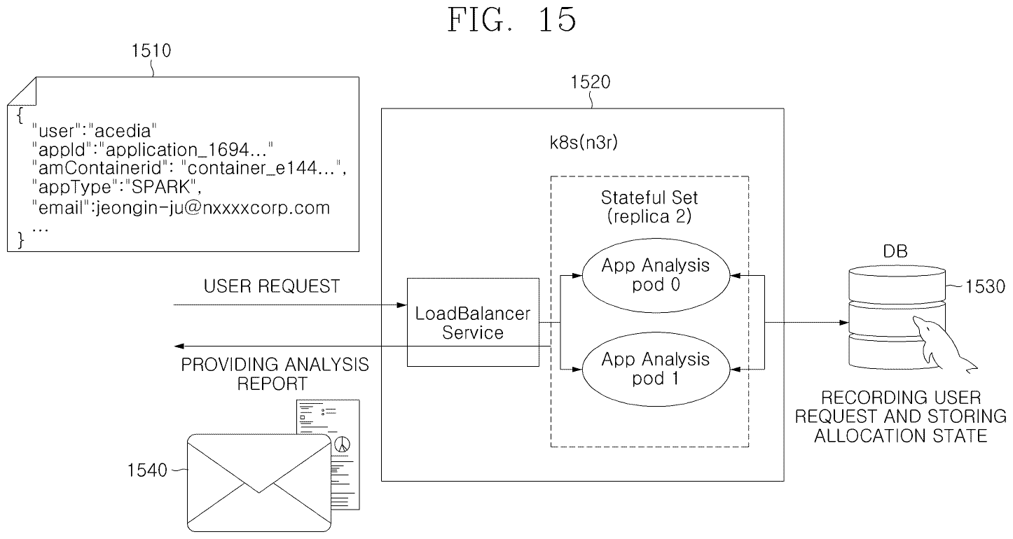

Accordingly, as may be seen in FIG. 15, the user may transmit an analysis request 1510 for his or her application to an analysis device 1520, so as to perform analysis on the application. According to some example embodiments, the analysis device 1520 may be the same as, similar to, or used to implement the analysis device 130 (and/or the analysis device 830). According to some example embodiments, operations described herein as being performed by the analysis device 1520 may be performed by processing circuitry.

In this case, the user's analysis request 1510 may include user identification (ID) information such as a user ID capable of identifying a user, application identification information such as an application ID for specifying the user's application, the type of framework (e.g., MapReduce, SPARK, etc.) on which the application is operated, and may also further request to include information difficult to derive from log files of the application targeted for analysis (e.g., setting values for the number of Executors actually available in SPARK, setting values for the number of Executors such as Mapper/Reducer and the like that are executable simultaneously or contemporaneously in MapReduce).

In this case, as may be seen in FIG. 15, the analysis device 1520 may be implemented to include one or more application analysis pods (e.g., App. Analysis pods) that perform analysis on a distributed processing application according to the present disclosure on the basis of Kubernetes, but this is only one example and the present disclosure is not necessarily limited thereto.

Accordingly, the analysis device 1520 may record the information about the user's request 1510 in a database 1530 and the like and store an allocation state, etc.

Then, when the analysis device 1520 completes the analysis of the application targeted for analysis, an analysis report 1540 may be provided to the user via email, or the like.

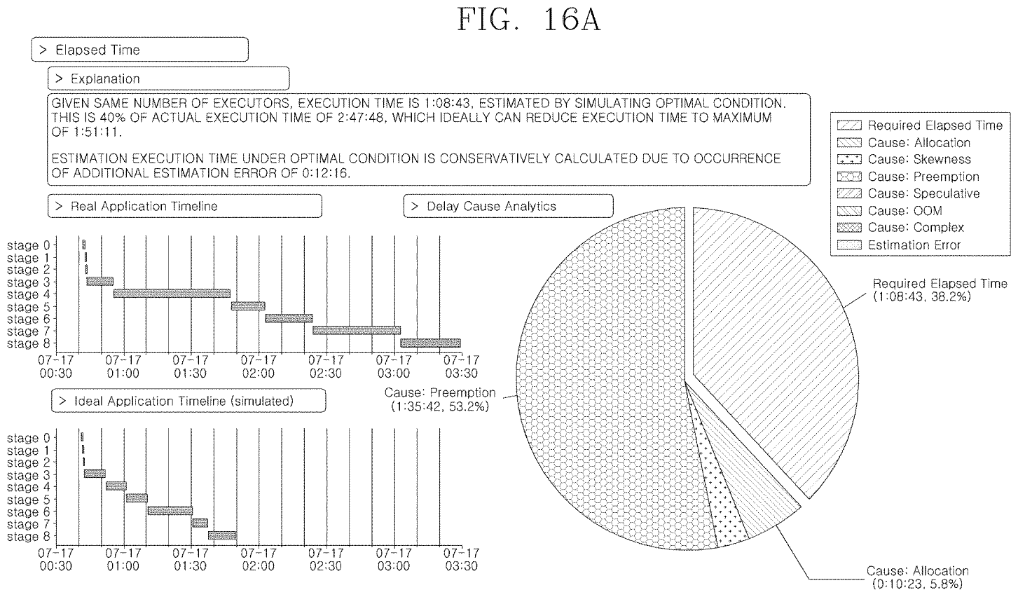

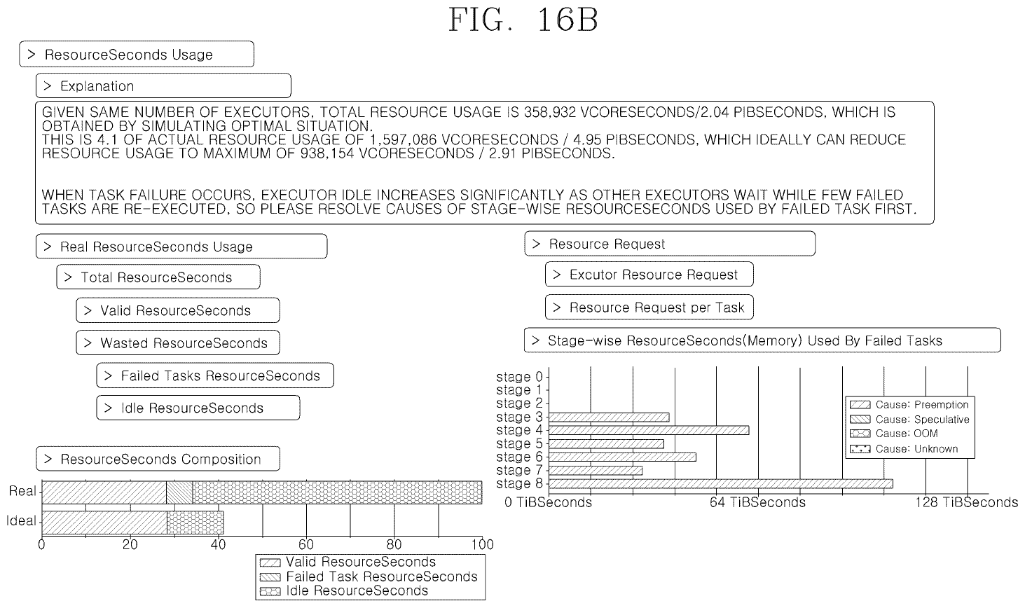

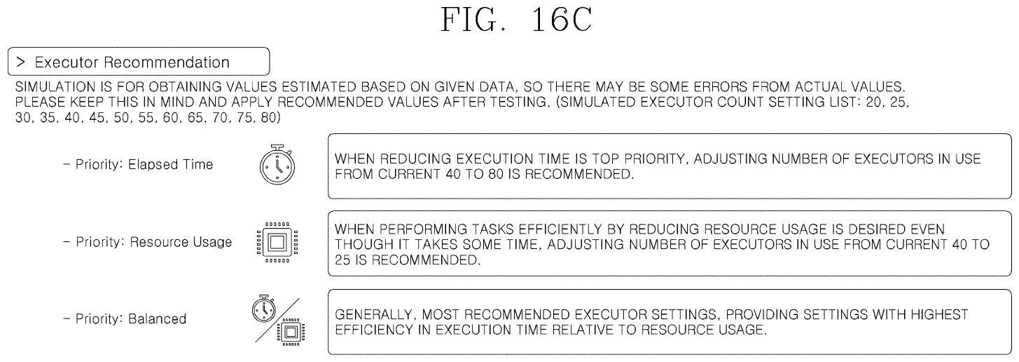

In this case, as shown in FIG. 16A, the analysis report 1540 may include analysis results on the degree of influence of each delay factor in terms of the time taken to perform the application.

In addition, as shown in FIG. 16B, the analysis report may include analysis results on the degree of influence, and the like, of each delay factor in terms of resource usage required (or otherwise, used) for application execution.

Furthermore, as shown in FIG. 16C, the analysis report may calculate and recommend optimal (or improved) setting values for the application for each objective (or priority), such as the time required (or otherwise, used) for application execute, the resource usage, and/or the efficiency.

In addition, a non-transitory computer-readable storage medium according to some example embodiments of the present disclosure may be a non-transitory computer-readable storage medium for storing instructions configured to cause a computing device including a processor to implement a specific operation when executed by the processor. In this case, a computer program may include a high-level language code executable on a computer by using an interpreter or the like, and include a machine language code generated by a compiler. In this case, the computer is not limited to a personal computer (PC) or a laptop computer, but is configured to include any information processing device, which is equipped with a central processing unit (CPU) and capable of executing the computer program, the information processing device being a server, a smartphone, a tablet PC, a PDA, a mobile phone, etc. In addition, the non-transitory computer-readable medium includes any non-transitory storage medium, which is readable by the computer, such as an electronic recording medium (e.g., a ROM, a flash memory, etc.), a magnetic storage medium (e.g., a floppy disk, a hard disk, etc.), an optical reading medium (e.g., a CD-ROM, a DVD, etc.), etc.

In addition, FIG. 17 illustrates a configuration and an operation of a device 50 for analyzing an application according to some example embodiments of the present disclosure.

Referring to FIG. 17, the device 50 may be the analysis device for analyzing the application according to the proposed method of the present disclosure.

For example, the device 50 to which the proposed method of the present disclosure is applicable may include: network devices such as repeaters, hubs, bridges, switches, routers, and gateways; computer devices such as desktop computers and workstations; mobile terminals such as smartphones; portable devices such as laptop computers; home appliances such as digital TVs; and mobility means such as automobiles. As another example, the device 50 to which the present disclosure is applicable may be included as part of an Application Specific Integrated Circuit (ASIC) implemented in the form of a System On Chip (SoC).

The memory 20 may be connected to the processor 10 during operation, may store programs and/or instructions for processing and controlling the processor 10, and may store: data and information used in the present disclosure; control information required (or otherwise, used) for data and information processing according to the present disclosure; temporary data generated during the data and information processing; and others. The memory 20 may be implemented as a storage device such as a Read Only Memory (ROM), a Random Access Memory (RAM), an Erasable Programmable Read Only Memory (EPROM), an Electrically Erasable Programmable Read-Only Memory (EEPROM), a flash memory, a Static RAM (SRAM), a Hard Disk Drive (HDD), a Solid State Drive (SSD), etc.

The processor 10 may be operatively connected to the memory 20 and/or the network interface device 30, and control the operation of each of these modules within the device 50. In particular, the processor 10 may perform various control functions for performing the proposed method of the present disclosure. The processor 10 may also be called a controller, a microcontroller, a microprocessor, a microcomputer, etc. The proposed method of the present disclosure may be implemented by hardware, firmware, software, or a combination thereof. When the present disclosure is implemented by using the hardware, the processor 10 may be provided with an application specific integrated circuit (ASIC) or a digital signal processor (DSP), a digital signal processing device (DSPD), a programmable logic device (PLD), a field programmable gate array (FPGA), etc., which are configured to perform the present disclosure. Meanwhile, when the proposed method of the present disclosure is implemented by using the firmware or software, the firmware or software may include instructions related to modules, procedures, or functions that perform functions or operations required (or otherwise, used) for implementing the proposed method of the present disclosure. The instructions may be stored in the memory 20 or be stored in the non-transitory computer-readable recording medium (not shown) separate from the memory 20, so as to be configured to cause the device 50 to implement the proposed method of the present disclosure when executed by the processor 10.

In addition, the device 50 may include a network interface device 30. The network interface device 30 is connected to the processor 10 when in operation, and the processor 10 controls the network interface device 30, so as to transmit or receive wireless/wired signals carrying information and/or data, signals, messages, and the like, through a wireless/wired network. For example, the network interface device 30 supports various communication standards such as, Institute of Electrical and Electronics Engineers (IEEE) 802 series, 3^{rd} Generation Partnership Project (3GPP) Long-Term Evolution (LTE)(-A), 3GPP 5G, and may transmit and receive control information and/or data signals according to a relevant communication standard. The network interface device 30 may also be implemented outside the device 50 as required (or otherwise, provided). According to some example embodiments, operations described herein as being performed by the device 50, the processor 10 and/or the network interface device 30 may be performed by processing circuitry.

Accordingly, the method, device, and non-transitory computer program for analyzing and improving the delay factors in the distributed data processing according to some example embodiments of the present disclosure may quantify and accurately identify the degrees of influence according to various delay factors that may occur during the execution of the user's application operated on the basis of the framework for the distributed data processing.

In addition, the method, device, and computer program for analyzing and improving the delay factors in the distributed data processing according to some example embodiments of the present disclosure may recommend or provide the operating environments for efficiently performing the application on the basis of the analysis of the application operated by the framework for the distributed data processing.

Conventional devices and methods for provide operating environments for executing applications based on large-scale distributed processing frameworks. However, the conventional devices and methods are unable to provide operating environments that enable efficient execution of the applications. For example, the conventional devices and methods are unable to accurately determine relative amounts of data processing delay contributed by various relevant factors, and thus, are unable to provide operating environments that effectively reduce this delay.

However, according to some example embodiments, improved devices and methods are provided for building operating environments. For example, the improved devices and methods perform a plurality of simulations across different operating environments reflecting different settings. The results of the simulations enable accurate determination of the relative amounts of data processing delay contributed by various relevant factors in the different operating environments. The improved devices and methods provide operating environments for efficiently executing applications based on settings corresponding to the determined relative amounts of data processing delay. Accordingly, the improved devices and methods overcome the deficiencies of the conventional devices and methods to build operating environments that improve the execution efficiency of applications in large-scale distributed processing frameworks.

Also, according to some example embodiments, the improved devices and methods may perform application-specific simulations to enable building of operating environments that improve the execution efficiency of the specific applications (e.g., on an application-by-application basis). Additionally, according to some example embodiments, the improved devices and methods may build the operating environments according to a priority, for example, one among a time taken for execution (e.g., execution delay), resource usage, or efficiency, such that the operating environments may be built to reduce execution delay, reduce resource consumption or increase efficiency according to the priority. According to some example embodiments, the priority may be input by a user (e.g., the user 840), stored in a memory (e.g., the memory 20), set (e.g., by the processor 10) based on a detected condition, etc.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order. Blocks may also be performed in iterative fashion. As used herein the term “and/or” includes any and all combinations of one or more of the associated listed items.

The above-described description is merely an example of the technical idea of the present disclosure, and those skilled in the art will appreciate that various modifications, additions and substitutions are possible, without departing from essential characteristics of the disclosure. Therefore, some example embodiments described in the present disclosure are not intended to limit the technical idea of the present disclosure but to describe the present disclosure, and the technical idea of the present disclosure is not limited by some example embodiments. The scope of protection of the present disclosure should be interpreted by the following claims, and all technical ideas within the scope equivalent thereto should be construed as being included in the scope of the present disclosure.

What is claimed is:

1. A method for performing analysis on an application that performs distributed processing of data, the method comprising:
generating, by processing circuitry, simulation information for simulations of the application based on log files corresponding to the application;
performing, by the processing circuitry, the simulations using the simulation information in a plurality of operating environments to obtain simulation results, the plurality of operating environments include an actual operating environment of the application and virtual operating environments, and one or more delay factors being removed in each of the virtual operating environments; and
conducting, by the processing circuitry, the analysis on the application based on the simulation results.

2. The method of claim 1, wherein the simulation information includes dependency relationships between one or more stages of the application.

3. The method of claim 2, wherein the simulation information includes execution details of one or more unit tasks included in the one or more stages.

4. The method of claim 3, wherein the simulation information includes one or more among:
a number of the one or more unit tasks included in the one or more stages;
a time taken to perform each of the one or more unit tasks; or
a delay factor that occurred in each of the one or more unit tasks.

5. The method of claim 3, wherein the simulation information includes information about one or more Executors to which the one or more unit tasks are allocated.

6. The method of claim 5, wherein the simulation information includes one or more among:
an allocation time for the one or more Executors; or
one or more delay factors that occurred in the one or more Executors.

7. The method of claim 1, wherein the performing comprises:
performing a first simulation for the application in the actual operating environment; and
performing second simulations for the application in the virtual operating environments in which the one or more delay factors are removed from the actual operating environment, the simulations including the first simulation and the second simulations.

8. The method of claim 7, wherein the virtual operating environments are configured by:
removing the one or more delay factors from the actual operating environment; and
combining the one or more delay factors from the actual operating environment.

9. The method of claim 1, wherein the conducting comprises:
calculating degrees of influence of the one or more delay factors on the application based on,
a first execution completion time of the application based on a first simulation in the actual operating environment, and
second execution completion times of the application based on second simulations in the virtual operating environments, the simulations including the first simulation and the second simulations.

10. The method of claim 9, wherein the calculating calculates each of the degrees of influence based on differences between the second execution completion times and the first execution completion time, the second execution completion times being based on each of the one or more delay factors.

11. The method of claim 10, wherein
the one or more delay factors include a plurality of delay factors; and
the conducting comprises calculating a composite degree of influence of two or more delay factors based on a subset of the second execution completion times, the plurality of delay factors including the two or more delay factors, the subset of the second execution completion times corresponding to a subject of the virtual operating environments in which the two or more delay factors are applied.

12. The method of claim 1, wherein
the performing performs the simulations by changing setting values for the application; and
the conducting includes generating first setting values for the application based on the analysis.

13. The method of claim 12, further comprising:
building, by the processing circuitry, a first operating environment based on the first setting values.

14. The method of claim 13, further comprising:
executing the application in a data distributed processing system based on the first operating environment.

15. A non-transitory computer-readable storage medium comprising:
instructions stored therein and configured to cause a computing device comprising a processor to implement a specific operation when executed by the processor, the specific operation including, generating simulation information for simulations of an application based on log files corresponding to the application,
performing the simulations using the simulation information in a plurality of operating environments to obtain simulation results, the plurality of operating environments including an actual operating environment of the application and virtual operating environments, and one or more delay factors are removed in each of the virtual operating environments, and
conducting analysis on the application based on the simulation results.

16. A device for performing analysis on an application that performs distributed processing of data, the device comprising:
at least one processor; and
a memory storing instructions configured to cause the device to implement a specific operation when executed by the processor, the specific operation including,
generating simulation information for simulations of the application based on log files corresponding to the application,
performing the simulations using the simulation information in a plurality of operating environments to obtain simulation results, the plurality of operating environments including an actual operating environment of the application and virtual operating environments, and one or more delay factors being removed in each of the virtual operating environments, and
conducting the analysis on the application based on the simulation results.

17. The device of claim 16 wherein the simulation information includes dependency relationships between one or more stages of the application.

18. The device of claim 16 wherein the performing comprises:
performing a first simulation for the application in the actual operating environment; and
performing second simulations for the application in the virtual operating environments in which the one or more delay factors are removed from the actual operating environment, the simulations including the first simulation and the second simulations.

19. The device of claim 16, wherein the conducting comprises:
calculating degrees of influence of the one or more delay factors on the application based on,
a first execution completion time of the application based on a first simulation in the actual operating environment, and
second execution completion times of the application based on second simulations in the virtual operating environments, the simulations including the first simulation and the second simulations.

20. The device of claim 16, wherein
the performing performs the simulations by changing setting values for the application; and
the conducting includes generating first setting values for the application based on the analysis.
